(19) United States
(12) Patent Application Publication
(10) Pub. No.: US 2010/0086021 A1
(43) Pub. Date: Apr. 8, 2010

(54) INFORMATION TRANSMISSION APPARATUS, METHOD OF CONTROLLING THE SAME, AND STORAGE MEDIUM

(75) Inventor: Yuka Utagawa, Kamakura-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/572,823

(22) Filed: Oct. 2, 2009

(30) Foreign Application Priority Data
Oct. 3, 2008 (JP) 2008-258566

(51) Int. Cl. H04N 11/04

(52) U.S. Cl. 375/240.01; 375/E07.001

(57) ABSTRACT

There is provided an information transmission apparatus which includes a reproduction information reception unit configured to receive reproduction information about reproduction of video data transmitted to a reception apparatus, a determination unit configured to determine a fragment size of the video data based on the reproduction information received by the reproduction information reception unit, a generation unit configured to generate a packet of the video data based on the fragment size determined by the determination unit, and a transmission unit configured to transmit the packet generated by the generation unit to the reception apparatus.

### BACKGROUND OF THE INVENTION

1. Field of the Invention

The present invention relates to an information transmission apparatus, a method of controlling the same, and a storage medium and, in particular, to a technique suitable for determining a fragment size of a data packet.

2. Description of the Related Art

Video data packetized in an information transmission apparatus generally passes through various communication lines when the video data is transmitted from a transmission source to a reception destination. A transferable maximum transmission unit (MTU) is determined for each communication line, and, as the case may be, a packet needs to be finely divided.

To cope with such a situation, a dividing process (fragmentation) of a packet is performed in the information transmission apparatus. The term “fragmentation” refers to a function to divide the packet into a plurality of packets to reduce a size per packet. The divided packet size is generally referred to as a fragment size.

Until now, in a technique for such a fragment, the fragment size is determined according to a type of a communication line from a transmission source to a reception destination and its size is generally fixed.

On the other hand, there is a technique for determining the fragment size according to a certain condition. Japanese Patent Application Laid-Open No. 2001-53805, for example, discusses a technique in which waiting time of a packet is measured and a fragment size is adjusted based upon a deviation of the waiting time.

Japanese Patent Application Laid-Open No. 2000-22749 discusses a technique in which delay time of a voice frame is periodically measured and a fragment process size that is optimum for a data frame is determined from the delay time when the delay time exceeds an allowance.

In streaming video data, it is desirable that the fragment size of a packet to be transmitted is small to avoid delay in video reproduction on the side of a reception apparatus. If the fragment size is large, it takes much time to transmit and decode the packet, and the delay time increases.

On the other hand, the smaller the fragment size of the packet to be transmitted, probably the higher a packet loss, so that completeness of a video to be reproduced on the reception apparatus may be lost.

Quality required for video data is different according to types of video data to be transmitted, transmission methods, and reproduction situations such as taste of a user viewing the video data. In other words, whether elimination of the delay in the video data to be reproduced (real-time characteristic) is prioritized or the completeness of video data is prioritized when the video data is reproduced by the reception apparatus depends on the reproduction status.

### SUMMARY OF THE INVENTION

The present invention is directed to establish compatibility between real-time characteristic and completeness of video data by determining a fragment size suited for reproduction status of the video data.

According to an aspect of the present invention, an information transmission apparatus includes a reproduction information reception unit configured to receive reproduction information about reproduction of video data transmitted to a reception apparatus, a determination unit configured to determine a fragment size of the video data based on the reproduction information received by the reproduction information reception unit, a generation unit configured to generate a packet of the video data based on the fragment size determined by the determination unit, and a transmission unit configured to transmit the packet generated by the generation unit to the reception apparatus.

According to an exemplary embodiment of the present invention, a fragment size is determined based on reproduction information about reproduction of video data to be transmitted to a reception apparatus, so that both the real-time characteristic and the completeness of video data can be ensured.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a functional configuration of an information transmission apparatus according to a first exemplary embodiment of the present invention.

FIG. 2 is a flow chart illustrating an example of procedure for determining a fragment size in the first exemplary embodiment of the present invention.

FIG. 3 is a graphical user interface (GUI) via which reproduction information is input on the side of a reception apparatus according to the first exemplary embodiment of the present invention.

FIG. 4 is an example of a fragment size table in the first exemplary embodiment of the present invention.

FIG. 5 is a block diagram illustrating an example of a functional configuration of an information transmission apparatus according to a second exemplary embodiment of the present invention.

FIG. 6 is a flow chart illustrating an example of procedure for determining a fragment size in the second exemplary embodiment of the present invention.

### DESCRIPTION OF THE EMBODIMENTS

Various exemplary embodiments, features, and aspects of the invention will be described in detail below with reference to the drawings.

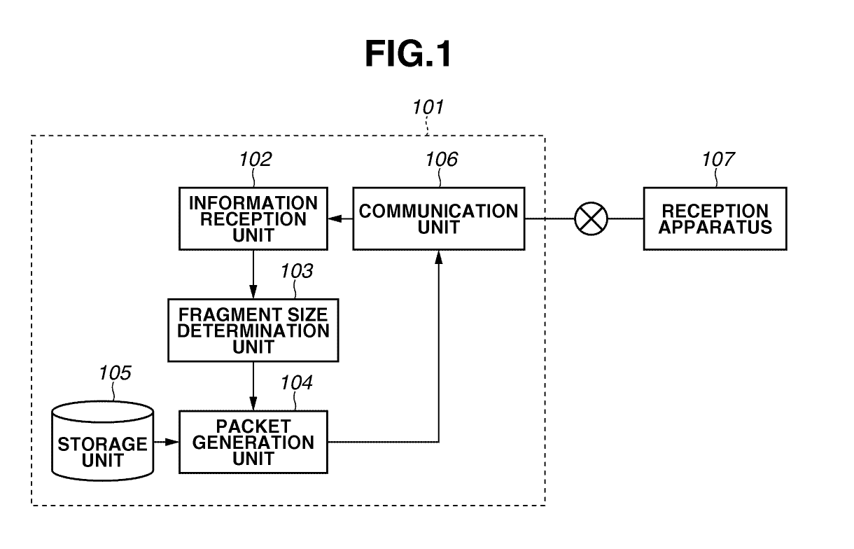

FIG. 1 is a block diagram illustrating an example of a functional configuration of an information transmission apparatus according to a first exemplary embodiment.

In the present exemplary embodiment, a fragment size is determined based on reproduction information about reproduction of video data.

A transmission apparatus 101 in the present exemplary embodiment in includes the following components. An information reception unit 102 functions as a reproduction information reception unit and obtains reproduction information about the reproduction of video data to be transmitted from a reception apparatus 107 via a communication unit 106. A fragment size determination unit 103 acts as a determination unit and determines a fragment size based on the reproduction information received in the information reception unit 102. A packet generation unit 104 functions as a generation unit and generates a packet for the video data to be transmitted based on the fragment size determined by the fragment size determination unit 103. A storage unit 105 stores the video data to be transmitted to the reception apparatus 107. The communication unit 106 functions as a transmission unit and transmits the packet generated by the packet generation unit 104 to the reception apparatus 107.

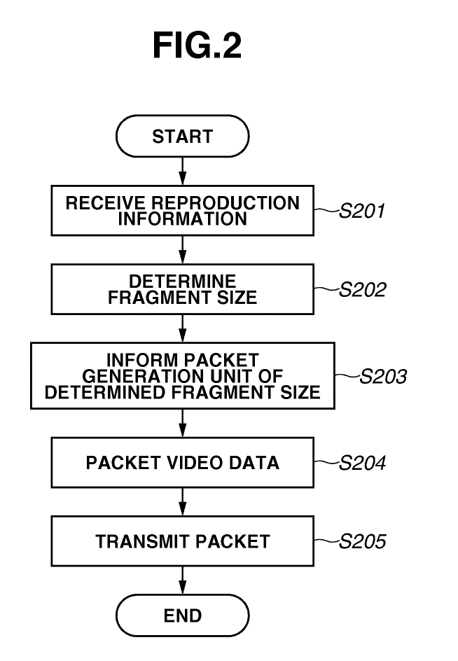

Referring to FIG. 2, there is described a process flow in which the fragment size of the video data to be transmitted is determined and the video data is transmitted to the reception apparatus 107 using the determined fragment size in the video transmission apparatus 101.

In step S201, the information reception unit 102 receives reproduction information about reproduction of video data from the reception apparatus 107. The reproduction information of the present exemplary embodiment indicates whether the video data to be transmitted is viewed in real-time. More specifically, the reproduction information indicates whether a user using the reception apparatus 107 views the video data to be transmitted in parallel with data reception (real-time streaming) or after the completion of data reception (downloading).

When the video data to be transmitted is viewed in parallel with data reception, the information reception unit 102 receives information indicating delay allowance of the video data as user setting information. In other words, the information reception unit 102 receives both information indicating whether the video data to be transmitted is viewed in real-time and the user setting information as the reproduction information.

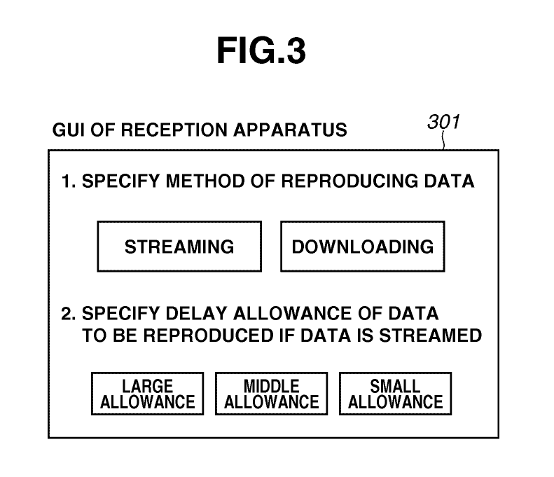

The reproduction information is specified by the user using the reception apparatus 107 via a graphical user interface (GUI). FIG. 3 illustrates an example in which the reproduction information displayed on the reception apparatus 107 is specified. In a window 301, the user can specify a data reproduction method and a delay allowance.

The user may specify information indicating real-time characteristic in addition to the delay allowance. Further, the user may specify information indicating the completeness of video data such as image quality setting items. In that case, these pieces of information are sent to the transmission apparatus 101 as the reproduction information.

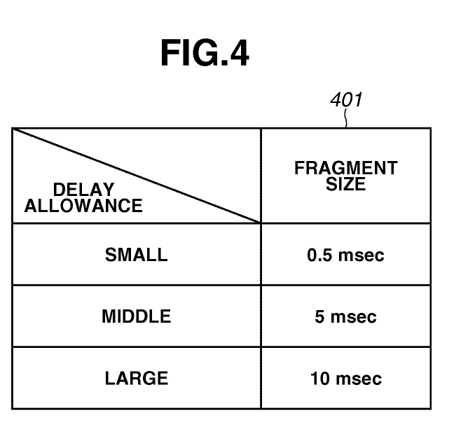

In step S202, the fragment size determination unit 103 refers to a fragment size table 401 based on the reproduction information. FIG. 4 illustrates the fragment size table 401. The fragment size table 401 indicates a relationship between a delay allowance included in the reproduction information and a fragment size. In FIG. 3, when the user specifies “STREAMING,” the fragment size determination unit 103 determines the fragment size of the video data to be transmitted smaller than that at the time of a normal data transmission. For example, if a fragment size at the time of the normal data transmission is set to 10 msec, the fragment size of the video data to be transmitted is set to 5 msec.

In FIG. 3, if the user specifies “SMALL ALLOWANCE,” the fragment size determination unit 103 sets a fragment size to 0.5 msec with reference to the fragment size table 401.

In FIG. 3, when the user specifies “DOWNLOADING,” the video data to be transmitted does not need to be real-time. For this reason, there may be used the fragment size at the time of the normal data transmission (a fixed value determined by a type of a communication line between a transmission source to a reception destination).

In step S203, the fragment size determination unit 103 notifies the packet generation unit 104 of the determined fragment size.

In step S204, the packet generation unit 104 packetizes the video data stored in the storage unit 105 based on the fragment size determined by the fragment size determination unit 103.

In step S205, the communication unit 106 transmits the packet generated by the packet generation unit 104 to the reception apparatus 107.

As described above, in the present exemplary embodiment, the fragment size at the time of streaming reproduction is made smaller than that at the time of downloading to ensure the real-time characteristic. Further, the fragment size is determined within a range in which the user allows delay at the time of streaming reproduction to establish compatibility between the real-time characteristic and the completeness of the video to be reproduced.

The transmission apparatus and the reception apparatus may be separately configured by a single information processing apparatus or may be configured by dividing the functions thereof into a plurality of information processing apparatuses as needed. If the transmission apparatus and the reception apparatus are configured by a plurality of computer apparatuses, the computer apparatuses are connected with one another so that the apparatuses can be mutually communicated.

In a second exemplary embodiment, the fragment size is determined based on not only the reproduction information received from the reception apparatus, but also information about free capacity of a packet reception buffer of the reception apparatus.

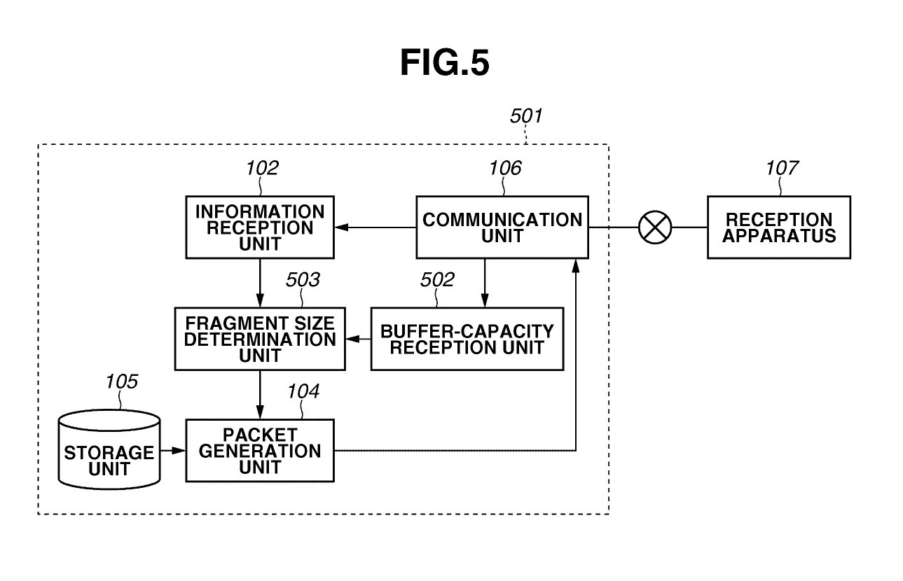

FIG. 5 is a block diagram illustrating an example of a functional configuration of an information transmission apparatus 501 according to the second exemplary embodiment. The description of the blocks executing the functions similar to those of the transmission apparatus 101 in the first exemplary embodiment are omitted herein.

A buffer-capacity reception unit 502 functions as a processing capacity reception unit and receives information about the free capacity of the packet reception buffer of the reception apparatus 107. A fragment size determination unit 503 determines a fragment size based on the reproduction information received by the information reception unit 102 and the information about the free capacity of the packet reception buffer received by the buffer-capacity reception unit 502.

The buffer-capacity reception unit 502 and the information reception unit 102 may function as a single reception unit.

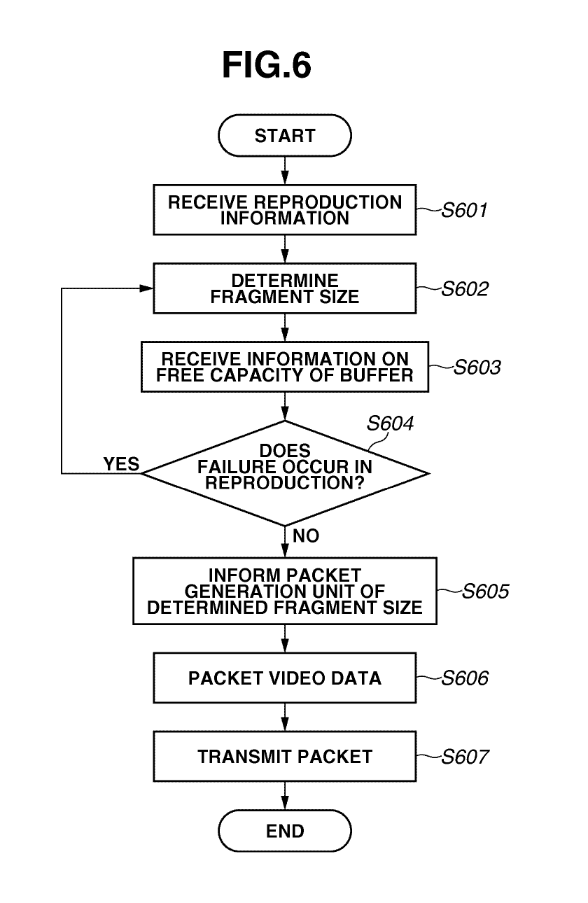

Referring to FIG. 6, there is described a process flow in which the fragment size of video data to be transmitted is determined and the video data is transmitted to the reception apparatus 107 using the determined fragment size in the transmission apparatus 501.

In step S601, the information reception unit 102 receives reproduction information about the reproduction of the video data from the reception apparatus 107.

In step S602, the fragment size determination unit 503 refers to the fragment size table 401 based on the reproduction information.

In step S603, the buffer-capacity reception unit 502 receives information indicating the free capacity of the buffer from the reception apparatus 107. The term “free capacity of the buffer” refers to the free capacity of the buffer for temporarily storing the received packet in the reception apparatus 107. The information indicating the free capacity of the buffer may be a specific memory size or a value indicating a ratio between the entire capacity and the free capacity of the buffer.

In step S604, the fragment size determination unit 503 determines whether failure in reproduction such as delay or buffer underrun occurs when a packet generated based on the fragment size determined in step S602 is transmitted. For example, suppose that a data amount indicated by the fragment size exceeds the free capacity of the buffer of the reception apparatus 107 even though the packet generated based on the fragment size determined in step S602 has been transmitted to the reception apparatus 107. In this case, buffer underflow occurs in the reception apparatus 107, and a problem that the video data cannot be normally reproduced is caused. Thus, if the fragment size determination unit 503 determines that the current fragment size causes failure on the side of the reception apparatus 107, the fragment size determination unit 503 determines again the fragment size based on the information indicating the free capacity of the buffer obtained from the buffer-capacity reception unit 502.

The fragment size determination unit 503 may use the fragment size table illustrated in FIG. 4 to determine again the fragment size. For example, if the data amount indicated by the fragment size may exceed the free capacity of the buffer of the reception apparatus 107 even though the packet generated based on the fragment size determined in step S602 has been transmitted to the reception apparatus 107, the fragment size determination unit 503 determines again the fragment size whose delay allowance determined in step S602 is lowered by one step.

A method for determining the fragment size is not limited to the above ones. For example, the fragment size determined in step S602 may be subjected to addition, subtraction, or multiplication. As another method, there may be used a fragment size table in which a fragment size is determined from the reproduction information and the information indicating the free capacity of the buffer of the reception apparatus 107. Alternatively, the free capacity of the buffer is always monitored to change a fragment size based on change in the free capacity of the buffer.

In step S605, the fragment size determination unit 503 notifies the packet generation unit 104 of the determined fragment size.

In step S606, the packet generation unit 104 packetizes the video data stored in the storage unit 105 based on the fragment size determined by the fragment size determination unit 503.

In step S607, the communication unit 106 transmits the packet generated by the packet generation unit 104 to the reception apparatus 107.

Although the present exemplary embodiment uses the information about the free capacity of the buffer as the processing capacity of the reception apparatus 107, information indicating the processing capacity of the reception apparatus (processing capacity information) is not limited to the above. Even information indicating a processing speed of a decoder of the reception apparatus or performance of a central processing unit (CPU), for example, can achieve a similar effect.

As described above, in the present exemplary embodiment, the fragment size is determined based on not only the reproduction information, but also the information about the free capacity of the packet reception buffer of the reception apparatus to establish compatibility between the real-time characteristic and the completeness the video to be reproduced.

The fragment size determination unit may determine a fragment size based on a situation in a communication line in addition to determination factors (such as the reproduction information and the free capacity of the buffer) described in the above exemplary embodiments.

A situation in a communication line can be known by measuring round trip time (RTT), for example. The term “round trip time” refers to time during which a packet is transferred between the transmission apparatus and the reception apparatus. The round trip time allows a user to presume a situation in a communication line.

More specifically, the fragment size determination unit measures the round trip time in parallel with transmission of a packet to determine a fragment size based on the round trip time. The fragment size is changed in synchronization with variation in the round trip time. For example, if the round trip time is increased at a certain point during the transmission of a packet, a possibility of losing the packet increases, so that the fragment size determination unit increases the fragment size. If the round trip time is decreased, on the other hand, the fragment size determination unit decreases the fragment size. A specific value may be determined according to an actual communication environment.

The method for determining a fragment size using the round trip time may be used solely or in combination with the foregoing exemplary embodiments.

Thus, a fragment size is determined based on a situation in a communication line to allow not only establishing compatibility between real-time characteristic and stability of the video to be reproduced, but also coping with a situation in a communication line and in particular variation in a situation in a line.

The fragment size determination unit may determine a fragment size based on a physical distance between the transmission apparatus and the reception apparatus. The physical distance between the transmission apparatus and the reception apparatus can be received by a global positioning system (GPS). The longer the distance, the higher the possibility of losing the packet. Therefore, if the physical distance between the transmission apparatus and the reception apparatus is long, the fragment size determination unit increases a fragment size.

The method for determining a fragment size using the physical distance may be used solely or in combination with the foregoing exemplary embodiments. In particular, the physical distance is a fixed value that does not vary during data transmission, so that the present method for determining a fragment size is effective in determining an initial value of a fragment size.

Aspects of the present invention can also be realized by a computer of a system or apparatus (or devices such as a CPU or a micro processing unit (MPU)) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-258566, filed Oct. 3, 2008, which is hereby incorporated by reference herein in its entirety.

What is claimed is:

1. An information transmission apparatus comprising:
a reproduction information reception unit configured to receive reproduction information about reproduction of video data transmitted to a reception apparatus;
a determination unit configured to determine a fragment size of the video data based on the reproduction information received by the reproduction information reception unit;
a generation unit configured to generate a packet of the video data based on the fragment size determined by the determination unit; and
a transmission unit configured to transmit the packet generated by the generation unit to the reception apparatus.

2. The information transmission apparatus according to claim 1, wherein the reproduction information reception unit receives information indicating whether the video data transmitted to the reception apparatus is reproduced in parallel with the reception of the video data.

3. The information transmission apparatus according to claim 2, wherein the determination unit makes smaller the fragment size in the case where the video data transmitted to the reception apparatus is reproduced in parallel with the reception of the video data than the fragment size in the case where the video data is not reproduced in parallel with the reception of the video data.

4. The information transmission apparatus according to claim 1, wherein the reproduction information reception unit receives information indicating whether the video data transmitted to the reception apparatus is reproduced in parallel with the reception of the video data and user setting information in the case where the video data is reproduced in parallel with the reception of the video data.

5. The information transmission apparatus according to claim 1, wherein the determination unit refers to a table indicating a relationship between the reproduction information received by the reproduction information reception unit and the fragment size to determine the fragment size of the video data.

6. The information transmission apparatus according to claim 1, further comprising:
a processing capacity reception unit configured to receive processing capacity information indicating a processing capacity of the reception apparatus, wherein
the determination unit determines the fragment size of the video data based on the reproduction information received by the reproduction information reception unit and the processing capacity information received by the processing capacity reception unit.

7. The information transmission apparatus according to claim 6, wherein the determination unit changes the fragment size determined based on the reproduction information received by the reproduction information reception unit on the basis of change in the processing capacity information.

8. A method for controlling an information transmission apparatus which transmits video data to a reception apparatus, the method comprising:
receiving reproduction information about reproduction of the video data transmitted to the reception apparatus;
determining a fragment size of the video data based on the received reproduction information;
generating a packet of the video data based on the determined fragment size; and
transmitting the generated packet to the reception apparatus.

9. A storage medium which stores a computer program for causing a computer to implement a method for controlling an information transmission apparatus which transmits video data to a reception apparatus, the computer program comprising:
receiving reproduction information about reproduction of the video data transmitted to the reception apparatus;
determining a fragment size of the video data based on the received reproduction information;
generating a packet of the video data based on the determined fragment size; and
transmitting the generated packet to the reception apparatus.
